(19) United States
(12) Patent Application Publication
(10) Pub. No.: US 2017/0034522 A1
(43) Pub. Date: Feb. 2, 2017

(54) WORKLOAD BALANCING IN MULTI-CORE VIDEO DECODER

(71) Applicant: FREESCALE SEMICONDUCTOR, INC., Austin, TX (US)

(72) Inventors: Hongzhang Yang, Shanghai (CN); Chaofan Huang, Suzhou (CN); Peng Zhou, Shanghai (CN)

(21) Appl. No.: 14/992,008

(22) Filed: Jan. 10, 2016

(30) Foreign Application Priority Data
Jul. 29, 2015 (CN) 201510610852.7

(51) Int. Cl. H04N 19/436; G06F 9/50; H04N 19/44

(52) U.S. Cl. CPC H04N 19/436; H04N 19/44; G06F 9/5011

(57) ABSTRACT

A multi-core decoder for decoding compressed video picture data decodes compressed video picture data. Multi-core processing resources parse compressed video picture data, and decode structures of picture data stored in a temporary storage. A control module adapts the resources of the cores by allocating at least one core to parse picture data serially, and allocating other cores to decode picture data in parallel. The multi-core processing resources are allocated between parsing and decoding picture data as a function of a workload parameter related to the relative workloads of the parsing and decoding operations.

### BACKGROUND

The present invention is directed to data compression and decompression and, more particularly, to balancing workloads in a multi-core video decoder.

Data compression is used for reducing the volume of data stored, transmitted or reconstructed (decoded and played back), especially for video content. Decoding recovers the video content from the compressed data in a format suitable for display. Various standards of formats for encoding and decoding compressed signals efficiently are available. Some standards that are commonly used are the International Telecommunications Union standards such as ITU-T H.264 ‘Advanced video coding for generic audiovisual services’, the standards of the Moving Picture Experts Group (MPEG), the VPx standards and the VC-1 standard.

Techniques used in video compression include inter-coding and intra-coding. Inter-coding uses motion vectors for block-based inter-prediction to exploit temporal statistical dependencies between items in different pictures (which may relate to different frames, fields, slices or macroblocks or smaller partitions). Intra-coding uses various spatial prediction modes to exploit spatial statistical dependencies (redundancies) in the source signal for items within a single picture. Prediction residuals, which define residual differences between the reference picture item and the currently encoded item, are then further compressed using a transform to remove spatial correlation inside the transform block before it is quantized during encoding. Finally, the motion vectors or intra-prediction modes are combined with the quantized transform coefficient information and encoded.

The decoding process involves taking the compressed data in the order in which it is received, decoding it for the different picture items, and combining the inter-coded and intra-coded items according to the motion vectors or intra-prediction modes. Decoding an intra-coded picture can be done without reference to other pictures, while decoding an inter-coded picture item uses the motion vectors together with blocks of sample values from a reference picture item selected by the encoder.

Decoding compressed video signals includes parsing parameters for a picture or slice from an input bit-stream. The parameters identify syntax element values, such as raw byte sequence payloads (RBSP) slice header, slice data and macroblock syntax elements. The parsing of the syntax elements enables the decoder to identify inter-coded and intra-coded items, any reference picture items, motion vectors or intra-prediction modes and prediction residuals, for example.

In a multi-core video decoder, the cores can be allocated to different tasks, and certain tasks can be performed by different cores in parallel. However, the parsing operations may be a bottleneck because there are interdependencies in variable length decoding and a picture may only contain one slice for resynchronization, restricting the performance of the decoder, to an extent that may be variable. It would be advantageous to have a multi-core video decoder in which the parsing and decoding operations were balanced in order to improve the overall performance of the decoder.

### BRIEF DESCRIPTION OF THE DRAWINGS

The present invention, together with objects and advantages thereof, may best be understood by reference to the following description of embodiments thereof shown in the accompanying drawings. Elements in the drawings are illustrated for simplicity and clarity and have not necessarily been drawn to scale.

FIG. 1 is a schematic block diagram of a multi-core video decoder in accordance with an embodiment of the invention;

FIG. 2 is a schematic block diagram of a data processing system that may be used in implementing the multi-core video decoder of FIG. 1;

FIG. 3 is a flow chart illustrating an example of parsing and decoding operations of the decoder of FIG. 1;

FIG. 4 is a flow chart illustrating evaluating parsing and decoding workloads in an example of operation of the decoder of FIG. 1;

FIG. 5 is a flow chart illustrating an operation of evaluating parsing and decoding workloads in another example of operation of the decoder of FIG. 1;

FIG. 6 is a flow chart illustrating a method of allocating cores to parsing and decoding in an example of operation of the decoder of FIG. 1; and

FIG. 7 is a timing chart illustrating the distribution of parsing and decoding between different cores in the method of FIG. 6.

### DETAILED DESCRIPTION

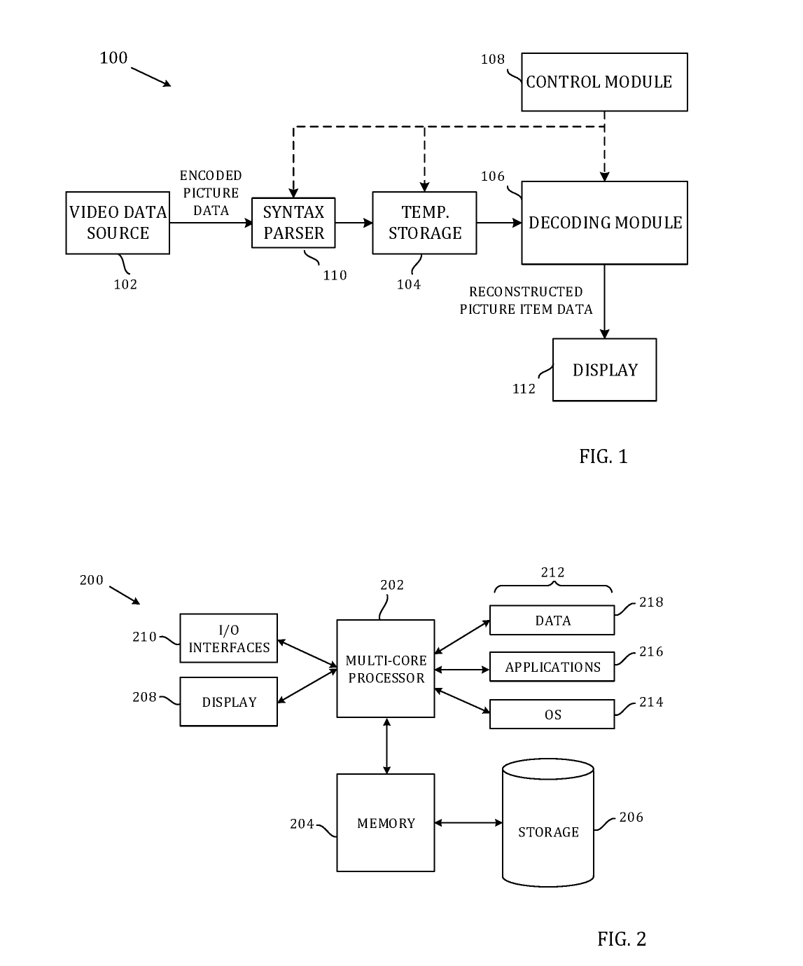

FIG. 1 illustrates a parallel decoder 100 for decoding compressed video picture data in accordance with an embodiment of the invention. The decoder 100 has multi-core processing resources providing at least one syntax parser 110 and at least one decoding module 106. The parser 110 parses compressed video picture data from a source 102 and structures of picture data to be decoded are stored in a temporary storage 104. The decoding module 106 decodes the stored picture data. A control module 108 controls the operation of the parser 110, the temporary storage 104 and the decoding module 106. The decoded picture data from the decoding module 106 can be reconstructed in a format suitable for displaying on a display screen 112. The present invention is applicable to pictures encoded in compliance with the standard H.264 AVC and also other standards.

FIG. 2 is a schematic block diagram of a data processing system 200 that may be used in implementing the parallel decoder. The data processing system 200 includes a multi-core processor 202 coupled to a memory 204, which may provide the temporary storage 104 of the parallel decoder 100, and additional memory or storage 206 coupled to the memory 204. The data processing system 200 also includes a display device 208, which may be the display screen 112 that displays the reconstructed picture data, input/output interfaces 210, and software 212. The software 212 includes operating system software 214, applications programs 216, and data 218. The data processing system 200 generally is known in the art except for the algorithms and other software used to implement the decoding of compressed video picture data described above. When software or a program is executing on the processor 202, the processor becomes a “means-for” performing the steps or instructions of the software or application code running on the processor 202. That is, for different instructions and different data associated with the instructions, the internal circuitry of the processor 202 takes on different states due to different register values, and so on, as is known by those of skill in the art. Thus, any means-for structures described herein relate to the processor 202 as it performs the steps of the methods disclosed herein.

The decoder 100 comprises multi-core processing resources 202 that perform parsing operations (110) and decoding operations (106) on picture data to be decoded. The multi-core processing resources 202 may perform parsing operations (110) in parallel with decoding operations (106). The control module 108 may adapt the resources of the cores by allocating each of a selected number of cores to parsing operations on data of a respective picture serially, and allocating other cores to decoding operations on picture data in parallel. The control module 108 may allocate the multi-core processing resources 202 between operations of parsing picture data (110) and decoding picture data (106) as a function of a workload parameter M, (T_{D}-T_{P}) related to the relative workloads of the parsing and decoding operations.

The adaptation of the multi-core processing resources 202 offers flexibility in balancing the parsing and decoding operations. The number of cores (one or more than one) that the control module 108 allocates to parsing operations can be selected to achieve a greater measure of balance between the parsing and decoding workloads. Certain cores can be allocated to parsing the data of respective pictures simultaneously; while the parsing operations of different pictures occur in parallel, each parsing core can parse serially the data of the respective picture, avoiding blocking the parsing operations. The decoding of one or more pictures can be distributed between one or more groups of the decoding cores in parallel.

The workload parameter M for current picture data may be related to relative durations P and D of parsing operations and of decoding operations for preceding picture data. The workload parameter M may be related to the relative values P/D of a duration P of parsing operations for preceding picture data that is a function of a difference between end and start times of the parsing operations on a core, and of a duration D of decoding operations that is a function of decoding times of samples of picture elements for the preceding picture data and of a sample rate. The duration D of decoding operations may be a function of the decoding times of the samples of picture elements after deduction of waiting times.

The workload parameter may be a time difference (T_{D}-T_{P}) between a completion time T_{D} of decoding operations and a completion time T_{P} of parsing operations for corresponding preceding picture data relative to a threshold value T_{TH}. The control module 108 may allocate 302 unchanged numbers N, (X−N) of the cores to the parsing operations and decoding operations as long as the parsing operations for current picture data are completed in time for prompt decoding operations for the same picture data.

The control module 108 may allocate respective numbers N, (X−N) of the cores to the parsing and decoding operations, and adapts the numbers 304 as a function of the workload parameter.

The control module 108 may allocate a plurality N of the cores to the N serial parsing operations of data of N respective pictures. The decoder 100 includes temporary storage 104 for storing the results of the parsing operations. The control module 108 allocates at least one other of the cores to decoding data of at least one picture using the stored parsing results.

The control module 108 may adapt the resources of the cores repeatedly as a function of at least one of the following criteria: periodically, detection of a change of bit rate of the picture data to be decoded, and/or a change in the number of the number X of cores available for parsing and decoding operations.

In more detail, in the decoding process 300 illustrated in FIG. 3, the workloads of parsing operations and decoding operations are evaluated at 306 as a function of the workload parameter M, (T_{D}-T_{P}). The control module 108 derives at 308 a number N of the cores in the multi-core processing resources 202 to allocate to the syntax parser 110. The N cores are allocated to the parser 110 at 310 and each perform serial operations of parsing data of a single picture item before parsing the following picture item, which accommodates the interdependency inside variable length decoding. Parsing of data for a given picture item runs on the same core until completion and is not blocked if the bit stream from the source 102 for that picture item is filled in time. However, the N cores allocated to the parser 110 parse data of N respective picture items in parallel. A number (X−N) of the other cores in the multi-core processing resources 202 are allocated at 312 to the decoder 106 and the data of one or more picture items is distributed to the (X−N) other cores for decoding in parallel, where X is the total number of cores available for parsing and decoding operations. Decoding a picture item can sometimes be blocked while waiting for parsing of the current item (such as a macroblock) to finish or for decoding of neighboring units to finish, for example.

At 314, a decision is taken whether to re-evaluate the number N of the cores in the multi-core processing resources 202 to allocate to the syntax parser 110. If the decision is not to re-evaluate the number N, the process proceeds at 302 to the next parsing operations 316. If the decision is to re-evaluate the number N, the process reverts to step 306 at 304. Factors influencing the decision 314 may include whether a change of bit rate of the picture data to be decoded is detected, and the calculation overhead associated with more frequent re-allocation of cores. Alternatively, or additionally, the decision 314 can be based on whether a change in the number of the number X of cores available for parsing and decoding operations occurs. Alternatively, the process can periodically revert 304 systematically to 306.

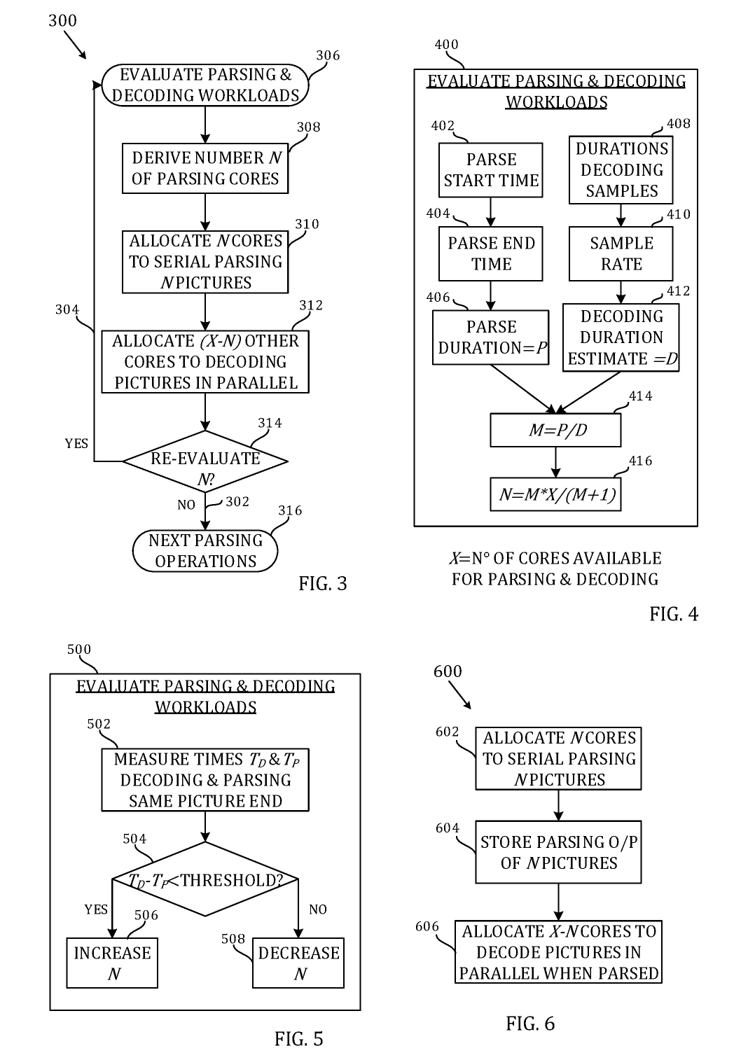

FIG. 4 illustrates an example of evaluating a workload parameter M for current picture data equal to the relative values P/D of a duration P of parsing operations for preceding picture data and of a duration D of decoding operations for the preceding picture data. Since parsing a picture item data runs on a single core serially, evaluating the duration P of a parsing operation is performed simply by registering 402 the start time of the parsing operation, registering 404 the completion time of the parsing operation, and subtracting the two to obtain the difference between the completion and start times. The decoding operations for a single picture item can run in parallel on more than one core. Accordingly duration D of the decoding operations is estimated by registering 408 decoding times of samples of picture elements for the preceding picture data, calculating the sample rate at 410 and multiplying the sum of the decoding times of the samples by the sample rate at 412. The estimate of the duration D of decoding operations at 412 is corrected by deduction of the sum of the waiting times of the samples, for example by setting the start times of the samples after the wait has finished. The parsing operations on the parsing core, may be faster or slower than the decoding operations on the decoding cores. Accordingly, M may be a multiple or a fraction, always greater than zero.

The workload parameter M for current picture data is calculated as the relative values P/D of the durations P and D of parsing and decoding operations for the preceding picture data at 414. At 416, the number cores allocated to the parser 110 is calculated as: N=M*X0M+1). If the number calculated is an integer, it can be applied directly. However, if N is not an integer, the next integer above can be used for a series of picture items and then the next integer below used for the next series. For example, if M=2 (parsing time is double the decoding time), X=8 (eight cores available), N=2*8/3. The number of cores can be balanced by using N=5 cores for 20 picture items and then N=6 cores for 10 picture items out of a total of 30 picture items.

FIG. 5 illustrates a method 500 of evaluating a workload parameter for current picture data equal to the time difference (T_{D}−T_{P}) between a completion time T_{D} of decoding operations and a completion time T_{P} of parsing operations for the same preceding picture data. At 502 the completion times T_{D} and T_{P} for decoding and parsing operations are registered. The decoding of a picture item depends on its parsing, so decoding is always completed after parsing. In the method 500, a threshold T_{TH} is defined for the time difference (T_{D}−T_{P}) between completion of parsing and decoding. At 504, a decision is taken whether the time difference (T_{D}−T_{P}) is less or greater than the threshold T_{TH}. If the time difference (T_{D}−T_{P}) is less than the threshold T_{TH} we assume decoding is faster, and at 506 the core resources devoted to parsing is increased by increasing the number N of cores allocated to the parser 110; otherwise we assume parsing is faster and the number N of cores allocated to the parser 110 is decreased. Alternatively, the number N of cores allocated to the parser 110 is based on the amount of (T_{D}−T_{P}−T_{TH}). In a complex system made up of different types of cores and having uneven core loadings, it is difficult to measure the accurate ratio of parsing time to decoding time as in 400. The method 500 enables a measure of relative workloads to be obtained with reduced computational complexity while obtaining a degree of balancing of the core resources between parsing and decoding operations.

The control module 108 may allocate at 302 unchanged numbers N, (X−N) of the cores to the parsing operations and decoding operations as long as the parsing operations for current picture data are completed in time for prompt decoding operations for the same picture data.

FIG. 6 illustrates a method 600 of allocating cores to parsing and decoding operations with balanced workloads. The serial parsing operations of N pictures are allocated to N respective cores in parallel at 602. The temporary storage 104 provides N buffers to store the parse outputs of the N cores at 604. Other cores (up to X−N, where X is the number of cores available for parsing and decoding operations) are allocated at 606 to decode data of at least one picture using the stored parsing results. The decoding operations are divided between the X−N cores and run in parallel with each other. The parsing operations of the N pictures on the N cores can start using pre-decoding application program interface (API) as soon as the input from the source 102 is available and can continue until completion. A core that has completed parsing a picture is then allocated to parse another picture.

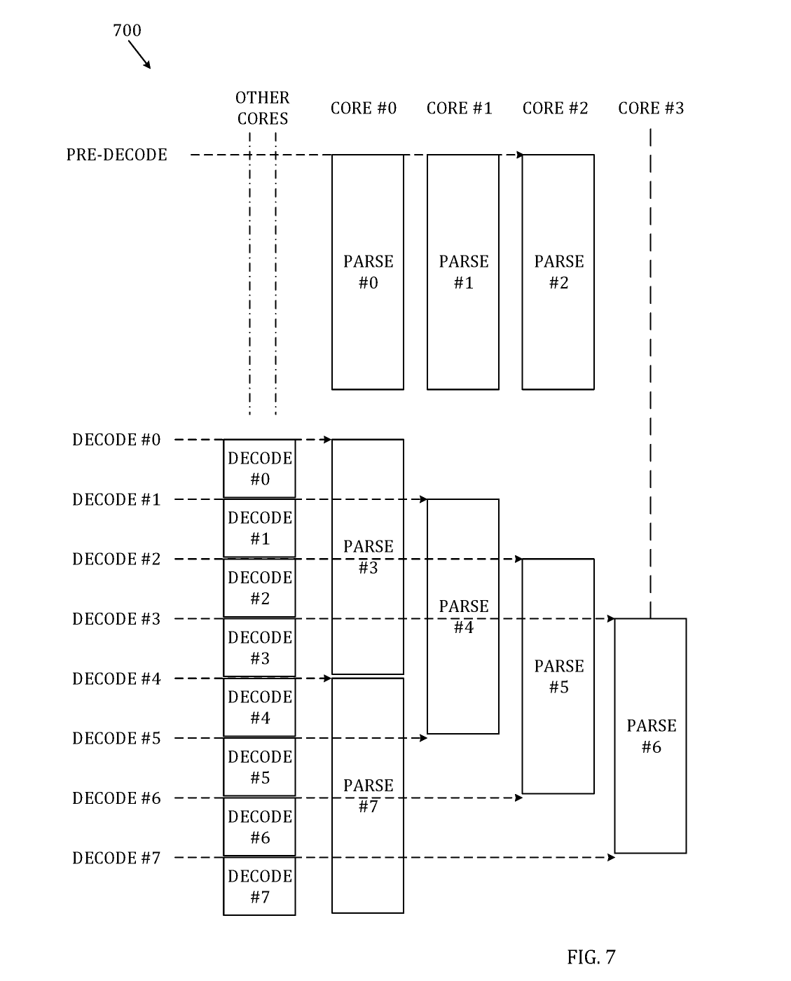

FIG. 7 illustrates the timing 700 of an example of the method 600 for a situation where four cores #0, #1, #2 and #3 are allocated to parsing operations, and the (X−4) other available cores are allocated to decoding. Initially, three of the cores #0, #1 and #2 start pre-decoding as soon as the input from the source 102 is available and store the parsing results as shown at Parse #0, Parse #1 and Parse #2. The (X−4) other available cores all decode in parallel at Decode #0 a first picture whose parsing results Parse #0 are available in the corresponding parsing buffer. The core #0 is then liberated to parse another picture and store the results Parse #3. The buffer is liberated after Decode #0 to store the results Parse #4. The (X−4) other available cores then all decode in parallel successively at Decode #1 and Decode #2 second and third pictures whose parsing results Parse #1 and Parse #2 are available in the corresponding parsing buffers. By that time, the parsing results Parse #3 from the core #0 are available in its buffer for the (X−4) other cores to decode in parallel at Decode #3, liberating the core #0 for Parse #7 and liberating its buffer to store the results of parsing another picture.

The invention may be implemented at least partially in a non-transitory machine-readable medium containing a computer program for running on a computer system, the program at least including code portions for performing steps of a method according to the invention when run on a programmable apparatus, such as a computer system or enabling a programmable apparatus to perform functions of a device or system according to the invention.

The computer program may be stored internally on computer readable storage medium or transmitted to the computer system via a computer readable transmission medium. All or some of the computer program may be provided on non-transitory computer-readable media permanently, removably or remotely coupled to an information processing system. The computer-readable media may include, for example and without limitation, any number of the following: magnetic storage media including disk and tape storage media; optical storage media such as compact disk media (e.g., CD ROM, CD R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM and so on; and data transmission media including computer networks, point-to-point telecommunication equipment, and carrier wave transmission media, just to name a few.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality. Similarly, any arrangement of components to achieve the same functionality is effectively “associated” such that the desired functionality is achieved. Hence, any two components combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

In the claims, the word ‘comprising’ or ‘having’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an”. The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A multi-core video decoder for decoding compressed video picture data, the decoder comprising:
multi-core processing resources including a plurality of cores that perform parsing operations in parallel with decoding operations on picture data to be decoded; and
a control module that allocates a selected number of the cores to serial data parsing operations of a respective picture, and allocates other cores to parallel picture data decoding operations.

2. The multi-core video decoder of claim 1, wherein the control module adapts the resources of the cores as a function of a workload parameter related to the relative workloads of the parsing and decoding operations.

3. The multi-core video decoder of claim 2, wherein the workload parameter for current picture data is related to relative durations of parsing operations and of decoding operations for preceding picture data.

4. The multi-core video decoder of claim 3, wherein the workload parameter is related to the relative values of a duration of parsing operations for preceding picture data that is a function of a difference between end and start times of the parsing operations on a core, and of a duration of decoding operations that is a function of decoding times of samples of picture elements for the preceding picture data and of a sample rate.

5. The multi-core video decoder of claim 4, wherein the duration of decoding operations is a function of the decoding times of the samples of picture elements after deduction of waiting times.

6. The multi-core video decoder of claim 3, wherein the workload parameter is a time difference between a completion time of decoding operations and a completion time of parsing operations for corresponding preceding picture data relative to a threshold value.

7. The multi-core video decoder of claim 6, wherein the control module allocates unchanged numbers of the cores to the parsing and decoding operations as long as the parsing operations for current picture data are completed in time for prompt decoding operations for the same picture data.

8. The multi-core video decoder of claim 2, wherein the control module allocates respective numbers of the cores to the parsing and decoding operations as a function of the workload parameter.

9. The multi-core video decoder of claim 1, wherein the control module allocates a plurality of the cores to the serial parsing operations of data of respective pictures, wherein the decoder includes temporary storage for storing the results of the parsing operations, and wherein the control module allocates at least one other of the cores to decoding data of at least one picture using the stored parsing results.

10. The multi-core video decoder of claim 1, wherein the control module allocates the cores repeatedly as a function of at least one of (i) periodically, (ii) detection of a change of bit rate of the picture data to be decoded, and (iii) a change in the number of the number of cores available for parsing and decoding operations.

11. A multi-core video decoder for decoding compressed video picture data, the decoder comprising:
multi-core processing resources including a plurality of cores that perform parsing and decoding operations on picture data to be decoded; and
a control module that allocates the cores between operations of parsing picture data and decoding picture data as a function of a workload parameter related to relative workloads of the parsing and decoding operations.

12. The multi-core video decoder of claim 11, wherein the control module allocates cores to serially parse data of respective pictures, and allocates other cores to decode picture data in parallel.

13. The multi-core video decoder of claim 11, wherein the workload parameter for current picture data is related to relative durations of parsing operations and of decoding operations for preceding picture data.

14. The multi-core video decoder of claim 13, wherein the workload parameter is related to the relative values of a duration of parsing operations for preceding picture data that is a function of a difference between end and start times of the parsing operations on a core, and of a duration of decoding operations that is a function of decoding times of samples of picture elements for the preceding picture data and of a sample rate.

15. The multi-core video decoder of claim 14, wherein the duration of decoding operations is a function of the decoding times of the samples of picture elements after deduction of waiting times.

16. The multi-core video decoder of claim 13, wherein the workload parameter is a time difference between a completion time of decoding operations and a completion time of parsing operations for corresponding preceding picture data relative to a threshold value.

17. The multi-core video decoder of claim 16, wherein the control module allocates unchanged numbers to the parsing and decoding operations as long as the parsing operations for current picture data are completed in time for prompt decoding operations for the same picture data.

18. The multi-core video decoder of claim 11, wherein the control module allocates respective numbers of the cores to the parsing and decoding operations, and adapts the numbers as a function of the workload parameter.

19. The multi-core video decoder of claim 11, wherein the control module allocates a plurality of the cores to the serial parsing operations of data of respective pictures, wherein the decoder includes temporary storage for storing the results of the parsing operations, and wherein the control module allocates at least one other of the cores to decoding data of at least one picture using the stored parsing results.

20. The multi-core video decoder of claim 11, wherein the control module adapts the resources of the cores repeatedly as a function of at least one of (i) periodically, (ii) detection of a change of bit rate of the picture data to be decoded, and (iii) a change in the number of the number of cores available for parsing and decoding operations.
